(19) United States
(12) Patent Application Publication
(10) Pub. No.: US 2007/0266860 A1
(43) Pub. Date: Nov. 22, 2007

(54) Dry beverage kit and a method of packaging

(76) Inventor: Satish Patel, Bear, DE (US)

Correspondence Address: PACIFIC RING SERVICES, INC., 1143 CHRISTINA MILL DRIVE, NEWARK, DE, 19711, US

(21) Appl. No.: 11/434,975

(22) Filed: May 16, 2006

(51) Int. Cl. A23L 1/00

(52) U.S. Cl. 99/275

(57) ABSTRACT

A dry beverage kit including a cup having a lid, a dry beverage mixture contained in the cup by means of the lid, a utensil; and printed material. The printed material includes instructions for preparation of a beverage and is present singly or in combination with one or more advertisements including coupons and/or vouchers.

### BACKGROUND OF THE INVENTION

A dry beverage is usually contained in a bottle or box. For example, when a person wants to prepare a cup of tea using powdered tea, he or she obtains a cup and heats water. The person then places tea powder, in the cup, and adds hot water to the tea powder. Additives such as cream, milk, sugar and/or spices may be added to the mixture of tea powder and water to suit the taste of the person consuming the tea. A spoon or a similar utensil must be available on hand to stir the various ingredients to make the tea suitable for consumption.

Cardboard packaging has been used to hold instant noodles but this packaging does not hold utensils or protect the noodles while the noodles are cooked in a cup.

### DETAILED DESCRIPTION OF THE INVENTION

The invention relates to a readymade kit including a cup with a lid along with a stirring utensil, printed material, and the like wherein a dry beverage mixture is contained in the cup utilizing the lid. This type of packaging allows a merchant to place a label on a cup and/or a box that holds the kit and ship it to a customer. Additionally, this type of packaging allows stacking of multiple boxes or cups in a shipping carton for ease of shipment to one or more customers.

In an embodiment, the invention relates to a dry beverage kit including a dry beverage mixture; a cup with a lid; a utensil; and printed material. The dry beverage mixture is sealed within the cup by means of the lid. The lid may be separate from the cup or integral with the cup and is readily removable from the cup.

The dry beverage mixture includes at least two ingredients such as a beverage powder, in combination with milk powder or creamer, sweeteners and condiments or the like. The beverage powder may be instant tea, instant coffee, cocoa, juice mix, etc. The milk powder may include non-fat, low fat or whole milk powder. Sweeteners may include sugar or sugar substitutes such as Splenda™ or the like. Condiments may include spices such as cardamom, cinnamon, ginger, etc.

The printed material includes instructions for preparing a beverage from the dry beverage mixture either present singly or in combination with one or more advertisements such as coupons and/or vouchers.

The utensil is a lightweight stirrer made of plastic or wood and could be in the form of a spoon or a spatula. The cup is made of heat resistant material such as Styrofoam, paper coated with a heat resistant material or plastic.

A beverage may be prepared by a person by opening the box, removing the lid from the cup, adding hot or cold water to the contents of the cup, and stirring the contents of the cup with a stirrer while using the box as a shield. Thus, the box not only serves to contain any spillage but also protects the person from the contents of the cup during preparation of a hot beverage such as tea, coffee or cocoa.

The invention is not limited to the embodiment described above but may vary within the scope of the subsequent claims regarding the use and design of the various parts and their function.

What is claimed is:

1. A method of packaging a dry beverage mixture comprising the steps of:
providing a cup having a lid;
providing a dry beverage mixture;
enclosing the dry beverage mixture within the cup by means of the lid;
providing a utensil; and
providing printed material.

2. The method of claim 1 wherein the printed material provided includes instructions for preparation of a beverage from the dry beverage mixture.

3. The method of claim 1 wherein the printed material provided is one or more advertisements.

4. The method of claim 3 wherein the advertisement is a coupon or voucher.

5. The method of claim 1 wherein the lid is separate from the cup.

6. The method of claim 1 wherein the lid is integral with the cup.

7. The method of claim 1 wherein the utensil is a lightweight stirrer.

8. The method of claim 1 wherein the cup is made of a heat resistant material.

9. A dry beverage kit comprising:
a dry beverage mixture;
a cup with a lid;
a utensil; and
printed material.

10. The kit of claim 9 wherein the dry beverage mixture is sealed within the cup by means of the lid.

11. The kit of claim 9 wherein the printed material contains instructions for preparing a beverage from the dry beverage mixture.

12. The kit of claim 9 wherein the printed material contains one or more advertisements.

13. The kit of claim 12 wherein the advertisement is a coupon or voucher.

14. The kit of claim 9 wherein the utensil is a lightweight stirrer.

15. The kit of claim 9 wherein the cup is made of heat resistant material.

16. The kit of claim 15 wherein the cup, lid, dry beverage mixture, utensil and printed material are packaged within a box.

17. The kit of claim 16 wherein the printed material contains instructions for preparing a beverage from the dry beverage mixture.

18. The kit of claim 17 wherein the printed material contains one or more advertisements.

19. The kit of claim 18 wherein the advertisement is a coupon or a voucher.

20. The kit of claim 15 wherein the utensil is a lightweight stirrer.

21. The kit of claim 15 wherein the cup is made of heat resistant material.
